(19) United States
(12) Patent Application Publication
(10) Pub. No.: US 2007/0146845 A1
(43) Pub. Date: Jun. 28, 2007

(54) THREE-DIMENSIONAL IMAGE REPRODUCING APPARATUS AND METHOD

(75) Inventors: Takashi Hirabara, Fukuoka (JP); Noboru Nakamura, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/613,723

(22) Filed: Dec. 20, 2006

(30) Foreign Application Priority Data
Dec. 21, 2005 (JP) P. 2005-367712
Aug. 31, 2006 (JP) P. 2006-235232

(51) Int. Cl. G03H 1/26

(52) U.S. Cl. 359/23

(57) ABSTRACT

A multi-ocular three-dimensional image reproducing apparatus reproduces a three-dimensional image by reproducing a plurality of light rays passing through a reproduction position of the three-dimensional image by means of a plurality of different parallax images, with a traveling direction of the light rays as a viewing direction. The apparatus includes a controller that coordinately controls a viewing direction of each of the parallax images, a position and size of a display region on a parallax image display device, and irradiation position, irradiation number and irradiation direction of the light rays reproduced by means of the parallax images.

### BACKGROUND OF THE INVENTION

The present invention relates to a three-dimensional image reproducing apparatus and a three-dimensional image reproducing method, and more particularly, to a three-dimensional image reproducing apparatus which is capable of easily reproducing a color three dimensional image or moving picture without using a coherent light source such as a laser, and a three dimensional reproducing method.

In the related art, there are two three-dimensional image reproducing methods: a binocular method of reproducing an image in three dimensions using a binocular parallax of eyes of a human and a holography method of reproducing a three-dimensional image using a wave front of light recorded as an interference fringe

However, the binocular method has drawbacks of impossibility of coincident sight of plural persons, eye fatigue in long-time viewing, lack of reality, etc., since this method can not make a three-dimensional image in reality although this method can reproduce and record an image in 3-dimensions. On the other hand, the holography method has not yet been put to practical use since this method needs a coherent light source, such as a laser, for recording and resolution of more than 1000 pixels/mm for a recording medium, although this method can make a complete three-dimensional image in reality.

In recent years, a multi-ocular three-dimensional image reproducing method is being spotlighted as a practical three-dimensional image reproducing method, apart from the twp above-mentioned methods.

The multi-ocular three-dimensional image reproducing method is disclosed in, for example, Japanese Patent Publication No. Hei10-239785, which will be described below.

FIG. 32 is a perspective view showing a conventional three-dimensional image reproducing apparatus. As shown in FIG. 32, a three-dimensional (3D) image reproducing apparatus employing a multi-ocular 3D image reproducing method includes a micro light source array 11 comprising a white light source 1 and a pin-hole array plate 2, an image forming lens 12 spaced apart by a focus length from the micro light source array 11, and a 3D image reproducing recording medium (or transparent 2D image display device) 13 interposed between the micro light source array 11 and the image forming lens 12. In FIG. 32, f represents a focus length of the image forming lens 12.

A multi-view image 16 comprising a plurality of parallax images 15 is recorded on the 3D image reproducing recording medium 13. The plurality of parallax images 15 can be optically recorded on the 3D image reproducing recording medium 13 when the pin-hole array plate 2 is interposed between an object (substance of a reproduced 3D image 14) and a recording medium (a negative plate of the 3D image reproducing recording medium 13) and the object is photographed in different viewing angles on different pin holes 21 of the pin-hole array plate 2, although not shown in the figure.

In addition, as shown in FIG. 32, the plurality of parallax images 15 are disposed on the 3D image reproducing recording medium 13 in such a manner that the parallax images 15 correspond to the pin holes 21 of the pin-hole array plate 2.

The reproduced 3D image 14 is reproduced when the multi-view image 16 comprising the plurality of parallax images 15 is displayed on the 3D image reproducing recording medium 13 and the plurality of parallax images 15 is formed by the image forming lens 12.

Now, viewing direction of the parallax images 15 will be described in detail. FIG. 33 is a perspective view illustrating the reproduction principle of the conventional 3D image reproducing apparatus. As shown in FIG. 33, a parallax image 91 is formed at a position of the reproduced 3D image 14 when a light beam 81 emitted from the micro light source array 11 passes through the 3D image reproducing recording medium, thereby forming a light beam 71, the light beam 71 is refracted by the image forming lens, thereby forming a light beam 61, and the light beam 61 is focused on the position of the reproduced 3D image 14.

Thus, without considering distortion of an image by the lens, reversion of an image, or the like, the parallax image 91 may be a lateral image of the reproduced 3D image when viewed from the viewing direction in which the light beam 61 is incident onto the center of a visual field of an observer.

Similarly, a parallax image 92 is formed at the position of the reproduced 3D image 14 when a light beam 82 emitted from the micro light source array 11 passes through the 3D image reproducing recording medium, thereby forming a light beam 72, the light beam 72 is refracted by the image forming lens, thereby forming a light beam 62, and the light beam 62 is focused on the position of the reproduced 3D image 14. Thus, the parallax image 92 may be another lateral image of the reproduced 3D image when viewed from the viewing direction in which the light beam 62 is incident onto the center of the visual field of the observer.

That is, a 3D image is reproduced when a plurality of lateral images from multi-view directions of the 3D image is disposed as parallax images at a position of the 3D image reproducing recording medium 13 and the parallax images are focused on the position of the reproduced 3D image 14 by the image forming lens.

Quality of the 3D image reproduced according to above-described method depends on “resolution of parallax images, that is, the number of pixels per one parallax image” and “the number of parallax images, that is, cubic effect by the number of view points of parallax images”.

Here, the cubic effect refers to a degree of natural variation of direction of a 3D image when an observation position of an observer who sees the 3D image is changed.

Therefore, “resolution of parallax images” and “the number of parallax images” on a transparent 2D image display device are limited by “size or resolution of multi-view image, that is, size or resolution of a transparent 2D image display device used”

That is, when the resolution of parallax images is increased, the number of parallax images is decreased, thereby deteriorating the cubic effect. Conversely, when the number of parallax images is increased to obtain a high cubic effect, the number of pixels of each parallax image is decreased, thereby lowering resolution of a reproduced 3D image.

If a displaying portion is large and a transparent 2D image display device having high resolution is used, it is theoretically possible to realize a 3D image having “high resolution” and “high cubic effect” together. However, such a transparent 2D image display device is generally expensive, which may result in rise of product costs.

As mentioned above, the multi-ocular 3D image reproducing method has a big problem to make “high resolution” and “high cubic effect” compatible with each other under a limited condition that the transparent 2D image display device is used.

The above-described multi-ocular 3D image reproducing apparatus employing the method multi-ocular 3D image reproducing method has difficulty in reproducing a 3D image with “high resolution” and “high cubic effect” compatible with each other under a limited condition that the transparent 2D image display device is used.

### SUMMARY OF THE INVENTION

An object of the invention is to provide a 3D image display apparatus, which is capable of reproducing a 3D image with “high resolution” and “high cubic effect” compatible with each other even under a limited condition that a transparent 2D image display device is used.

To achieve the object of the invention, the invention provides a multi-ocular three-dimensional image reproducing apparatus for reproducing a three-dimensional image by reproducing a plurality of light rays passing through a reproduction position of the three-dimensional image by means of a plurality of different parallax images, with a traveling direction of the light rays as a viewing direction, comprising a controller that coordinately controls a viewing direction of each of the parallax images, a position and size of a display region on a parallax image display device, and irradiation position, irradiation number and irradiation direction of the light rays reproduced by means of the parallax images.

According to the invention, a display region of a transmission-typed two-dimensional displaying apparatus can be effectively used as time-division frames by the number of kinds of arrangement of parallax images of a multi-view image to be changed. In addition, it is possible to reproduce a 3D image with “high resolution” and “high cubic effect” compatible with each other even under a limited condition that a transparent 2D image display device is used.

According to a first aspect, the invention provides a multi-ocular three-dimensional image reproducing apparatus for reproducing a three-dimensional image by reproducing a plurality of light rays passing through a reproduction position of the three-dimensional image by means of a plurality of different parallax images, with a traveling direction of the light rays as a viewing direction, comprising a controller that coordinately controls a viewing direction of each of the parallax images, a position and size of a display region on a parallax image display device, and irradiation position, irradiation number and irradiation direction of the light rays reproduced by means of the parallax images. With this configuration, a display region of a transmission-typed two-dimensional displaying apparatus can be effectively used as time-division frames by the number of kinds of arrangement of parallax images of a multi-view image to be changed. In addition, it is possible to reproduce a 3D image with “high resolution” and “high cubic effect” compatible with each other even under a limited condition that a transparent 2D image display device is used.

According to a second aspect, the invention provides a multi-ocular three-dimensional image reproducing method for reproducing a three-dimensional image by reproducing a plurality of light rays passing through a reproduction position of the three-dimensional image by means of a plurality of different parallax images, with a traveling direction of the light rays as a viewing direction, wherein a viewing direction of each of the parallax images, a position and size of a display region on a parallax image display device, and irradiation position, irradiation number and irradiation direction of the light rays reproduced by means of the parallax images are periodically changed With this configuration, a display region of a transmission-typed two-dimensional displaying apparatus can be effectively used as time-division frames by the number of kinds of arrangement of parallax images of a multi-view image to be changed. In addition, it is possible to reproduce a 3D image with “high resolution” and “high cubic effect” compatible with each other even under a limited condition that a transparent 2D image display device is used.

According to a third aspect, the invention provides a three-dimensional image reproducing apparatus including a dynamic point light source array that dynamically controls at least one of positions of point light sources, the number of point light sources, and diameter of point light sources, an image forming lens that is spaced apart by a focus length from the dynamic point light source array, and a transparent two-dimensional image display device that is interposed between the dynamic point light source array and the image forming lens, comprising a controller that coordinately controls the positions of point light sources, the number of point light sources, and the diameter of point light sources of the dynamic point light source array, a viewing direction of a parallax image on a display image of the transparent two-dimensional image display device, and a parallax image display region position on the transparent two-dimensional image display device. With this configuration, a display region of a transmission-typed two-dimensional displaying apparatus can be effectively used as time-division frames by the number of kinds of arrangement of parallax images of a multi-view image to be changed. In addition, it is possible to reproduce a 3D image with “high resolution” and “high cubic effect” compatible with each other even under a limited condition that a transparent 2D image display device is used.

According to a fourth aspect, the invention provides a three-dimensional image reproducing method for reproducing a three-dimensional image using a dynamic point light source array that dynamically controls at least one of positions of point light sources, the number of point light sources, and diameter of point light sources, an image forming lens that is spaced apart by a focus length from the dynamic point light source array, and a transparent two-dimensional image display device that is interposed between the dynamic point light source array and the image forming lens, wherein a viewing direction of each of the parallax images on the transparent two-dimensional image display device, a position of a display region of the parallax image on the transparent two-dimensional image display device, and the positions of point light sources, the number of point light sources, and the diameter of point light sources are periodically changed for a short time that can not be discriminated by eyes. With this configuration, a display region of a transmission-typed two-dimensional displaying apparatus can be effectively used as time-division frames by the number of kinds of arrangement of parallax images of a multi-view image to be changed. In addition, it is possible to reproduce a 3D image with “high resolution” and “high cubic effect” compatible with each other even under a limited condition that a transparent 2D image display device is used.

According to a fifth aspect, resolution of the parallax image and the number of parallax images are changed to according to a characteristic and use of a display three-dimensional image. With this configuration, a three-dimensional image having high image quality according to use of scenes and characteristics of images can be obtained.

According to a sixth aspect, three-dimensional image quality can be momentarily controlled to according to a characteristic and use of a display three-dimensional image by changing resolution of the parallax image and the number of parallax images. With this configuration, for reproduction of a moving picture, a three-dimensional image having high image quality according to use of scenes and characteristics of images can be obtained.

According to a seventh aspect, the invention provides a three-dimensional image reproducing method A three-dimensional image displaying apparatus comprising: a two-dimensional image displaying part that includes a plurality of element image displaying parts for displaying element images; a lens array that is disposed in a light ray traveling direction of the two-dimensional image displaying part and includes a plurality of element lenses that pass light rays of the element image displaying parts; an element image-element lens correspondence changing part that changes correspondence of the element image displaying parts to the element lenses that pass the light rays from the element image displaying parts; and a time-division synchronization image displaying part that instructs the element image-element lens correspondence changing part to change the correspondence of the element image displaying parts to the element lenses and displays the element images on the element image displaying part in time-division according to the instruction. With this configuration, a cross-talk can be avoided, and a viewing angle can be widened.

According to an eighth aspect, the two-dimensional image displaying part comprises a projection-typed displaying part. With this configuration, a cross-talk can be avoided, and a viewing angle can be widened.

According to a ninth aspect, the element image-element lens correspondence changing part comprises a light path changing part. With this configuration, a cross-talk can be avoided, and a viewing angle can be widened.

According to a tenth aspect, the element image-element lens correspondence changing part comprises a wavelength selection filter. With this configuration, a cross-talk can be avoided, and a viewing angle can be widened.

According to an eleventh aspect, the element image-element lens correspondence changing part comprises a polarizing filter. With this configuration, a cross-talk can be avoided, and a viewing angle can be widened.

According to a twelfth aspect, the division number of element images displayed on the element image displaying part in time-division is equal to the number of changes of the element image-element lens correspondence changing part. With this configuration, a cross-talk can be avoided, and a viewing angle can be widened.

According to a thirteenth aspect, a viewing angle θ of a three-dimensional image satisfies an equation of θ>2arctan(p/(2g)) (where p is a pitch of an element lens and g is a distance between the two-dimensional image displaying part and the lens array). With this configuration, a cross-talk can be avoided, and a viewing angle can be widened.

According to a fourteenth aspect, the invention provides a three-dimensional image displaying method for displaying a plurality of element image and projecting a three-dimensional image by passing the three-dimensional image through a lens array comprising element lenses corresponding to the element images, the method comprising the steps of: displaying the plurality of element images on element image displaying parts; instructing change of the element image displaying part and the element lenses corresponding to the element image displaying parts; changing correspondence of the element image displaying parts to the element lenses based on the instruction; and repeating the steps of displaying the plurality of element images, instructing change of the element image displaying part and the element lenses, and changing correspondence of the element image displaying parts to the element by the number of changes of the correspondence of the element images to the element lens. With this configuration, a cross-talk can be avoided, and a viewing angle can be widened.

### BRIEF DESCRIPTION OF THE DRAWINGS

FIG. 1 is a perspective view showing a 3D image reproducing apparatus according to an embodiment of the invention.

FIG. 2 is a perspective view showing a 3D image reproducing apparatus according to an embodiment of the invention.

FIG. 3 shows a model for explaining a 3D image reproducing method according to an embodiment of the invention.

FIG. 4 shows a model for explaining a 3D image reproducing method according to an embodiment of the invention.

FIG. 5 shows a model for explaining a 3D image reproducing method according to an embodiment of the invention.

FIG. 6 shows a model for explaining a 3D image reproducing method according to an embodiment of the invention.

FIG. 7 shows a model for explaining a 3D image reproducing method according to an embodiment of the invention.

FIG. 8 shows a model for explaining a 3D image reproducing method according to an embodiment of the invention.

FIG. 9 shows a model for explaining a 3D image reproducing method according to an embodiment of the invention.

FIG. 10 shows a model for explaining a 3D image reproducing method according to an embodiment of the invention.

FIG. 11 shows a model for explaining a 3D image reproducing method according to an embodiment of the invention.

FIG. 12 shows a model for explaining a 3D image reproducing method according to an embodiment of the invention.

FIG. 13 shows a model for explaining a 3D image reproducing method according to an embodiment of the invention.

FIG. 14 shows a model for explaining a 3D image reproducing method according to an embodiment of the invention.

FIG. 15 is a flow chart illustrating a 3D image reproducing method according to an embodiment of the invention.

FIG. 16 is a view showing constituent elements of a 3D image display apparatus according to a forth embodiment of the invention.

FIG. 17 is an explanatory view of an operation of element image-element lens correspondence changing means (M=3).

FIG. 18 is a flow chart illustrating an operation of time-division synchronization image displaying means.

FIG. 19 is an explanatory view of the principle of widening a viewing angle.

FIG. 20 is a simplified form of a portion of FIG. 19.

FIG. 21 is a simplified form of FIG. 20.

FIG. 22 shows constituent elements of a 3D image display device according to a fifth embodiment of the invention.

FIG. 23 is a view showing change of correspondence of element images to element lenses according to a sixth embodiment of the invention.

FIG. 24 is a view showing change of correspondence of element images to element lenses according to a sixth embodiment of the invention.

FIG. 25 is a view showing change of correspondence of element images to element lenses according to a sixth embodiment of the invention.

FIG. 26 shows constituent elements of a 3D image display device according to a seventh embodiment of the invention.

FIG. 27A is an explanatory view of an example of the seventh embodiment.

FIG. 27B is an explanatory view of an example of the seventh embodiment.

FIG. 27C is an explanatory view of an example of the seventh embodiment.

FIG. 28 shows constituent elements of a 3D image display device according to an eighth embodiment of the invention.

FIG. 29A is an explanatory view of an example of a positional relation between the element lenses, the element image displaying parts and the polarizing filter in V polarization display of the display device.

FIG. 29b is an explanatory view of an embodiment in which the element image-element lens correspondence changing means is taken as the polarizing filter.

FIG. 30A is a view showing a relation between a focus length of an element lens and a viewing angle.

FIG. 30B is a view showing a relation between a focus length of an element lens and a widened viewing angle.

FIG. 31 is a view showing a 3D pixel configuration in a stripe pattern of a display device.

FIG. 32 is a perspective view showing a conventional three-dimensional image reproducing apparatus.

FIG. 33 is a perspective view illustrating the reproduction principle of the conventional 3D image reproducing apparatus.

### DETAILED DESCRIPTION OF PREFERRED EMBODIMENTS

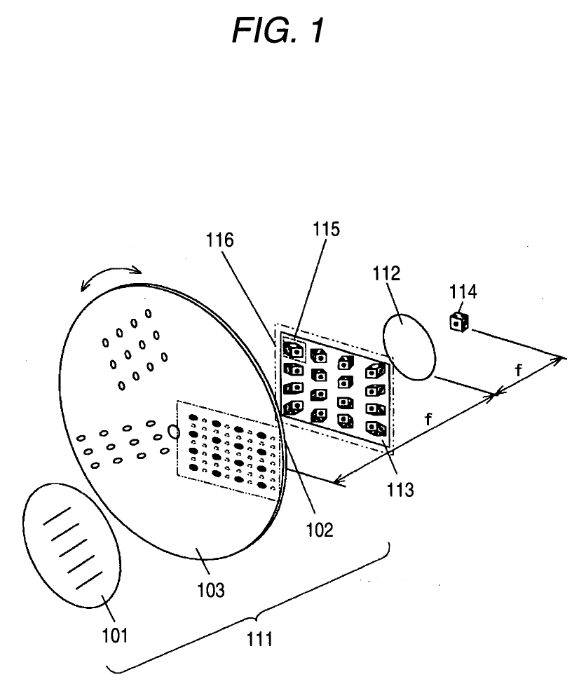

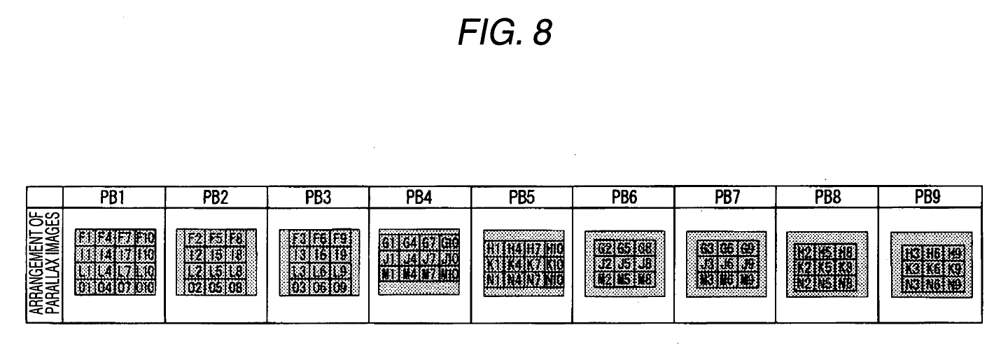

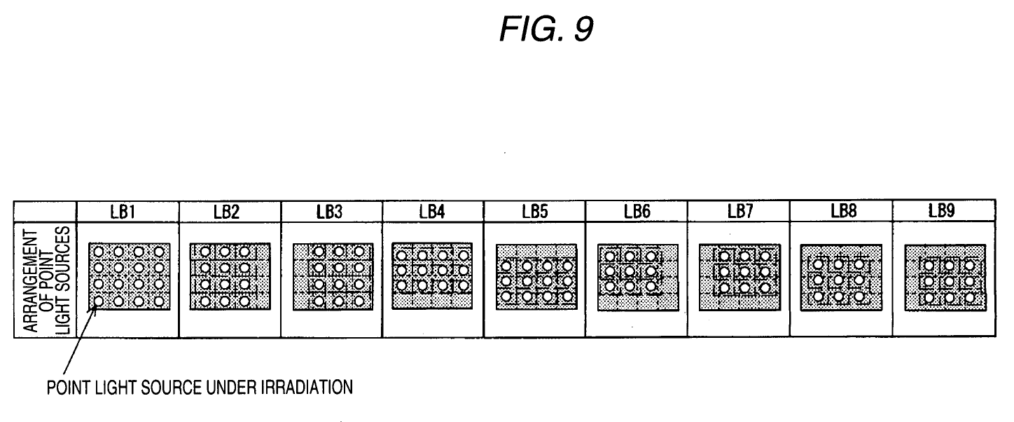

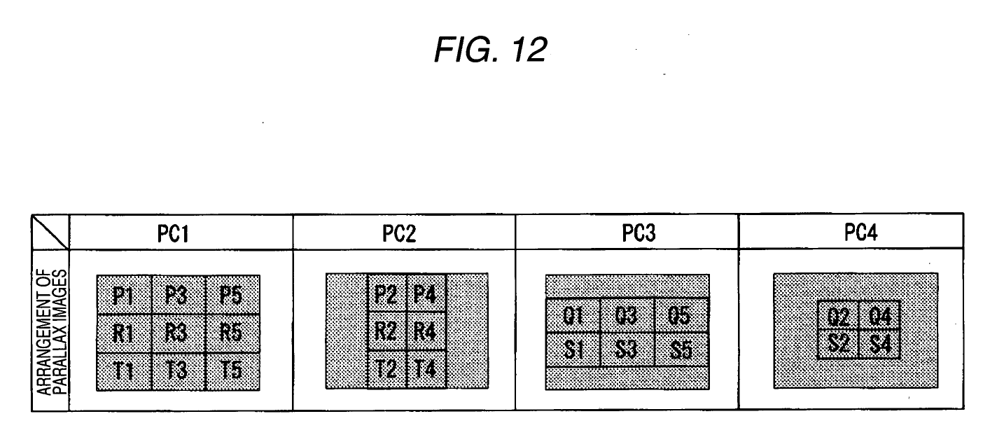

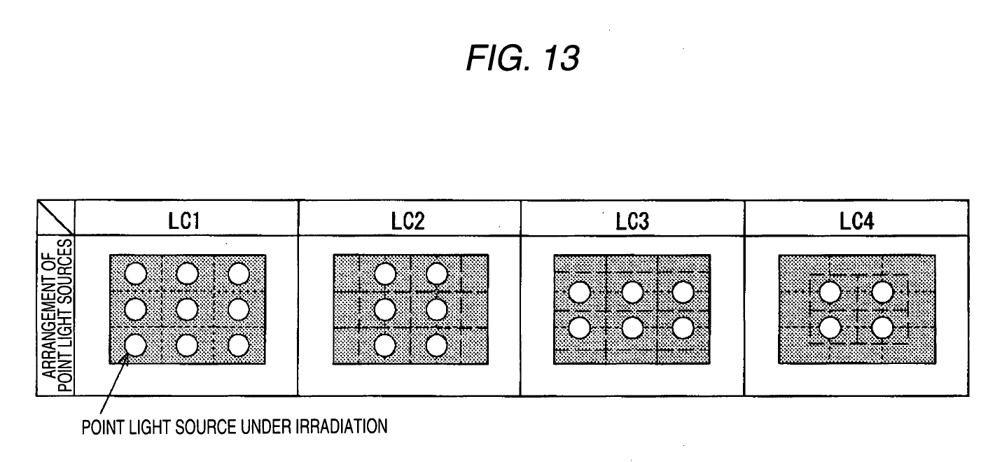

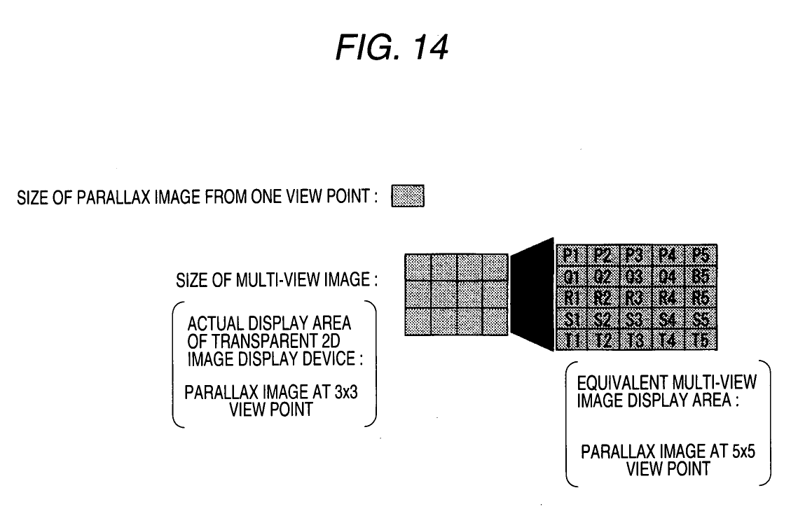

Hereinafter, exemplary embodiments of the invention will be described with reference to FIGS. 1 to 31.

### First Embodiment

FIG. 1 is a perspective view showing a 3D image reproducing apparatus according to an embodiment of the invention. As shown in FIG. 1, a dynamic point light source array 111 irradiates reproduction light to reproduce an image of a transparent 2D image display device 113.

In addition, the dynamic point light source array 111 includes a white light source 101, a pin-hole array plate 102 for defining a traveling direction of the reproduction light, and a shutter plate 103 that is interposed between the white light source 101 and the pin-hole array plate 102 and selectively blocks pin holes of the pin-hole array plate 102.

An image forming lens 112 serves to superpose parallax images, which are displayed on the transparent 2D image display device 113, on a position at which a reproduced 3D image is placed, from a plurality of different view points.

The transparent 2D image display device 113, such as a liquid crystal display device, serves to display a multi-view image 116 of the reproduced 3D image 114.

In addition, although it has been shown and illustrated above that the dynamic point light array 111 includes a combination of the white light source 101, the pin-hole array plate 102 and the shutter plate 103 that selectively blocks pin holes of the pin-hole array plate 102, the dynamic point light array 111 may include “combination of the white light source, the pin-hole array plate, and a dynamic shutter such as a liquid crystal shutter”, “combination of the white light source, a lens array, and the shutter plate”, “combination of the white light source, the lens array, and the dynamic shutter such as the liquid crystal shutter”, or “combination of the white light source and the dynamic shutter such as the liquid crystal shutter”.

Light emitted from the dynamic point light source array 111 passes through the transparent 2D image display device 113. The multi-view image 116 comprising parallax images 115 from a plurality of different view points is displayed on transparent 2D image display device 113.

As described above, after a light ray emitted from a different position of the dynamic point light source array 111 passes through a particular position at which the transparent 2D image display device 113 is placed, the light ray forms an element image of a 3D reproduce image as an image from a particular sight direction by the image forming lens 112.

Here, a point light source arrangement of the dynamic point light source array 111 is changed.

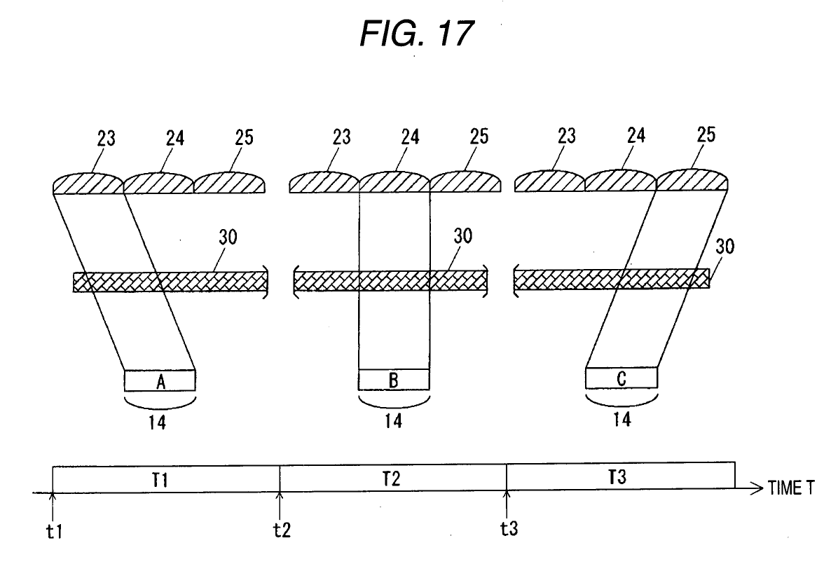

Then, as shown in FIG. 17, a light ray emitted from a position A different from a position before change passes through a particular position B of the transparent 2D image display device 113, a traveling direction of the light ray is changed by the image forming lens 112, and then, the light ray passes through a position of the reproduced 3D image as a light ray from a direction C different from a direction before the change. When a parallax image from the direction C of an angle of the light ray that passes through the position of the reproduced 3D image is disposed at the particular position B on the transparent 2D image display device 113, an image from a view direction different from the direction before the change is newly added as an element image of the reproduced 3D image 114.

Like this, when “position of point light source” or “optical characteristic such as a diameter of point light source or a spread angle of light ray” of the dynamic point light source array 11” and “view direction and position of parallax image displayed on the transparent 2D image display device 113” are synchronized and are changed in so a short time as not to be discriminated by eyes, the reproduced 3D image 114 comprising the plurality of parallax images can be viewed by an afterimage effect. According to this principle, even if resolution of the transparent 2D image display device 113 or a size of a displaying part is not changed, the number of view points of the parallax images can be increased, with keeping resolution of the parallax images constant, by synchronizing and changing the multi-view image and the dynamic point light source array and displaying the multi-view image, which comprises the parallax images from a plurality of different view points, as a time-division frame on the transparent 2D image display device 113. A change method will be described in detail below as a second embodiment.

In addition, in the first embodiment, change of“view direction of parallax images and position and size of a display region of a parallax image display device” is achieved by the transparent 2D image display device 113, and change of “irradiation position, number and direction of light ray reproduced by parallax images” is achieved by the dynamic point light source array 111. Also, the transparent 2D image display device 113 is in coordination with the dynamic point light source array 111.

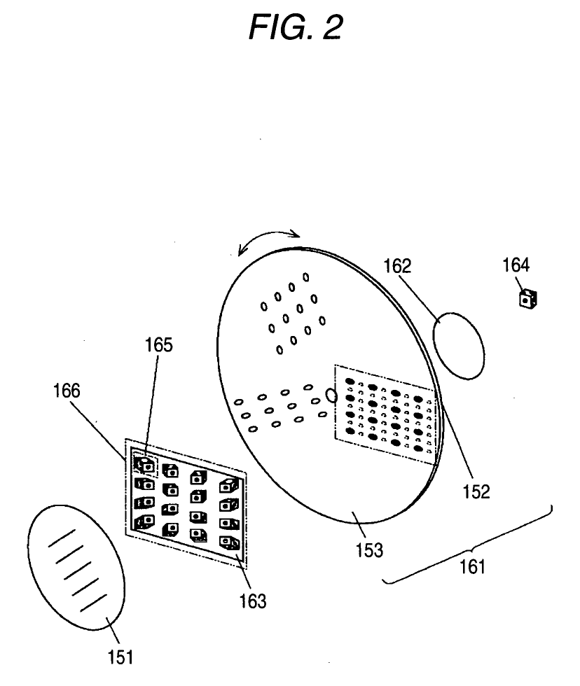

In addition, for example, as shown in FIG. 2, it may be considered that a dynamic pin-hole array 161 comprising a shutter plate 153 and a pin-hole array plate 152 is interposed between a transparent 2D display device 163 and a image forming lens 162, or the image forming lens 162 is not present in FIG. 2, as in Patent Document 1, if the reproduced 3D image lies in a remote place. FIG. 2 is a perspective view showing another example of the 3D image reproducing apparatus according to an embodiment of the invention.

Here, in FIG. 2, change of“irradiation position, number and direction of light ray reproduced by parallax images” is achieved by the dynamic pin-hole array 161.

In addition, although it has been shown and illustrated above that the dynamic pin-hole array 161 includes the pin-hole array plate 152 and the shutter plate 153 that selectively blocks pin holes of the pin-hole array plate 152, the dynamic pin-hole array 161 may include “combination of the pin-hole array plate and a dynamic shutter such as a liquid crystal shutter”, “combination of a lens array and the shutter plate” or “combination of the lens array and the dynamic shutter such as the liquid crystal shutter”.

### Second Embodiment

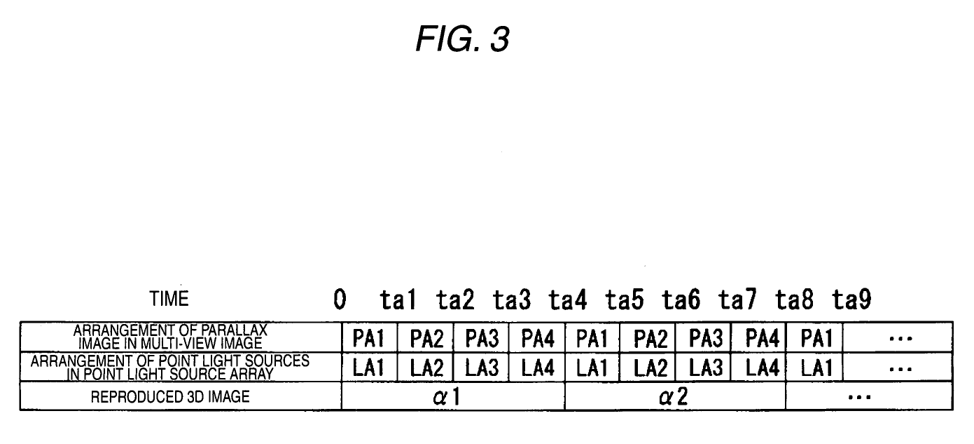

FIGS. 3 to 14 show models for explaining a 3D image reproducing method according to an embodiment of the invention. FIGS. 3 to 14 show models of different examples of the basically same 3D image reproducing method, except number and position of the parallax images and arrangement and diameter of point light sources of the dynamic point light source array.

An actual display region of the parallax images is determined by a distance between the dynamic point light source array and the transparent 2D image display device, the diameter of the point light sources, and the like, and there exist regions not used for display between the parallax images.

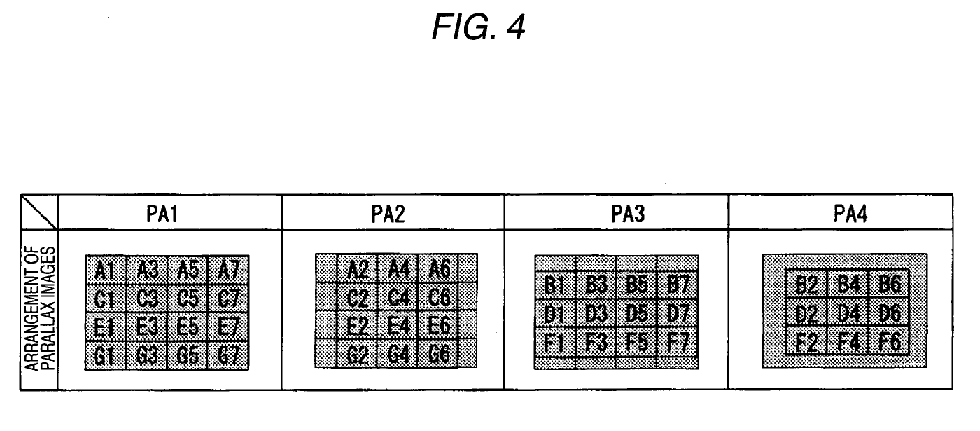

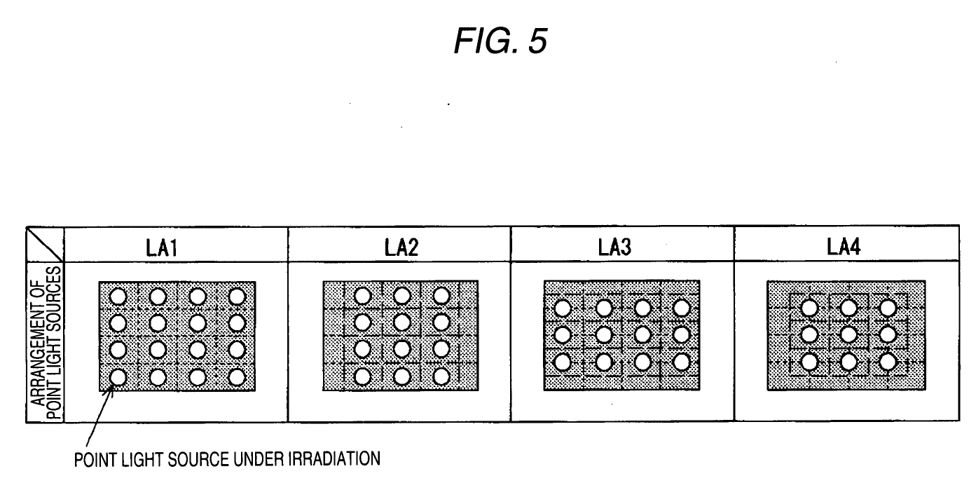

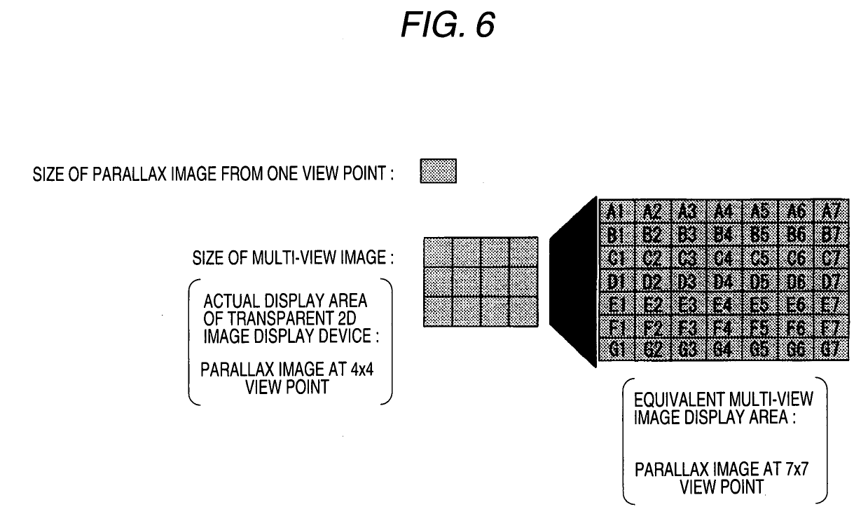

However, in these models, the regions not used for display are omitted, and adjacent parallax image display regions are indicated by adjacent rectangular forms. Of these figures, FIGS. 3, 7 and 11 show timing charts of the 3D image display method, FIGS. 4, 6 and 12 show arrangement of parallax images of a multi-view image displayed on the transparent 2D image display device 113, FIGS. 5, 9 and 13 show arrangement of point light sources on the dynamic point light source array 111, and FIGS. 6, 10 and 14 show a relationship between “actual display area of the transparent 2D image display device” and “equivalent multi-view image display area” realized by the invention.

To begin with, a 3D image reproducing method according to an embodiment of the invention will be described in connection with FIG. 2 showing the example where parallax images are deviated from one another by ½ of a parallax image region in both of horizontal and vertical directions and are disposed as time-division frame 2D images.

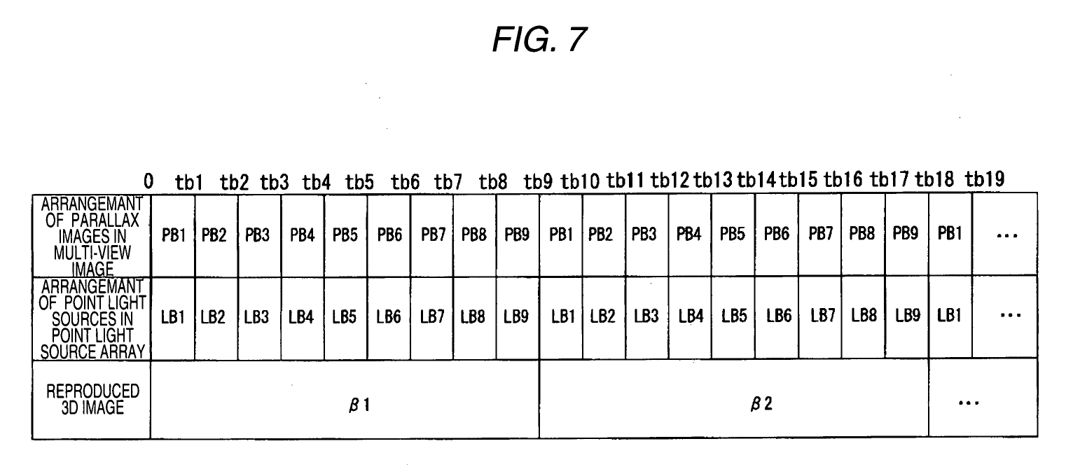

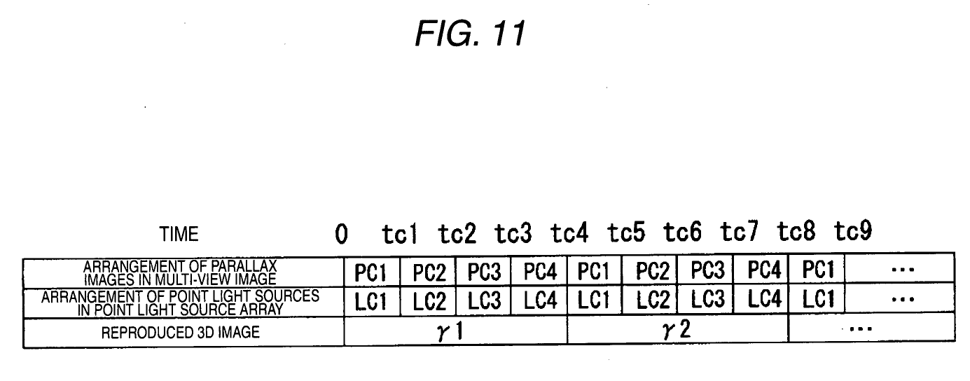

FIG. 3, ta1, ta2, . . . represent time, PA1, PA2, . . . represent arrangement of parallax images of a multi-view image displayed on the transparent 2D image display device 113, LA1, LA2, . . . represent arrangement of point light sources on the dynamic point light source array 11 of FIG. 5, and α1, α2, . . . represent frames of a reproduced 3D image. In FIG. 4, A1, A2, . . . represent display regions of the parallax image in FIG. 6. In addition, in symbols A1 to J10 representing parallax image regions, A to G represent arrangement order of the parallax images of the multi-view image in a vertical direction, and 1 to 7 represent arrangement order of the parallax images of the multi-view image in a horizontal direction. This is similarly applied to parallax region symbols F1 to O10 in FIGS. 7 to 10 and parallax region symbols P1 to T5 in FIGS. 11 to 14.

As shown in a timing chart of FIG. 3, in a time zone of 0 to ta1, 16 parallax images at arrangement positions corresponding to {A1, A3, AS, A7, C1, C3, CS, C7, E1, E3, E5, E7, G1, G3, G5 and G7} of 49 view points shown in an upper potion of FIG. 6 are arranged as a multi-view image as shown in PA1 of FIG. 4. In this time zone, the dynamic point light source array 111 irradiates point light at positions shown in LA1 of FIG. 5.

Similarly, in a time zone of ta1 to ta2, point light sources of LA2 of FIG. 5 irradiate a multi-view image arranged in PA2 of FIG. 4, and, in a time zone of ta2 to ta3, point light sources of LA3 of FIG. 5 irradiate a multi-view image arranged in PA3 of FIG. 4. If the time zones of 0 to ta3 is so short as not to be discriminated by eyes, one reproduced 3D image α1 corresponding to the 49 view points shown in the upper potion of FIG. 6 is viewed by an afterimage effect of eyes. That is, one 3D image α1 is formed by three time-division frames of 0 to ta1, ta1 to ta2, and ta2 to ta3, and, as shown in FIG. 6, a 3D image corresponding to the 49 parallax images A1 to G7 is reproduced in the transparent 2D image display device of a display area having 16 parallax images. A 3D image including a moving picture continues to be reproduced when the above-described parallax image arrangement process is continuously performed periodically.

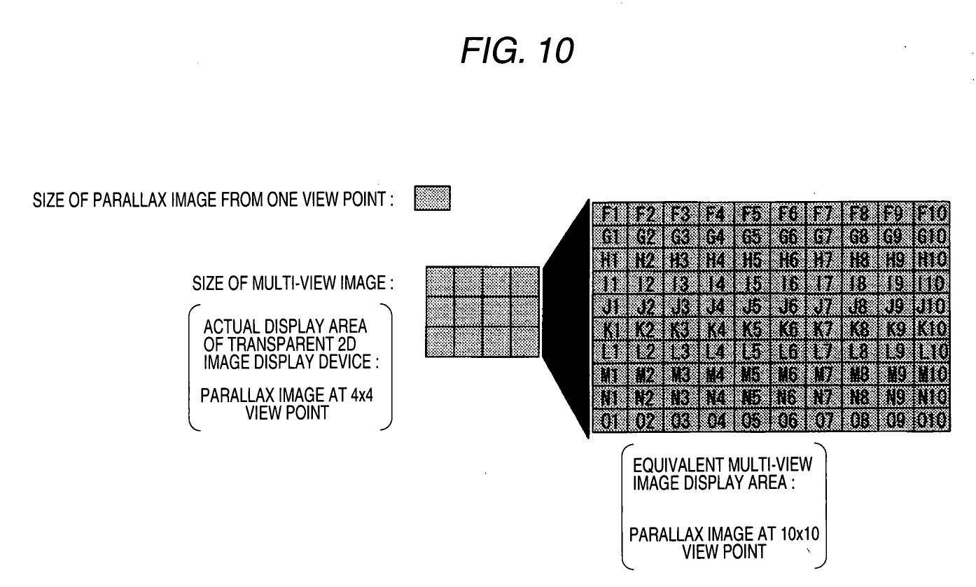

Next, FIGS. 7 to 10 show examples where parallax images are deviated from one another by ⅓ of a parallax image region in both of horizontal and vertical directions and are disposed as time-division frame 2D images. In this case, one 3D image β1 is formed by nine time-division frames of 0 to tb1, tb1 to tb2, . . . , and tb8 to tb9, and, as shown in FIG. 10, a 3D image corresponding to 100 parallax images F1 to 010 is reproduced in the transparent 2D image display device of a display area having 16 parallax images.

As a third example, FIGS. 11 to 14 show an example where the diameter and spread angle of the point light sources are changed, and display size of the parallax images are increased. In these figures, parallax images are deviated from one another by ½ of a parallax image region in both of horizontal and vertical directions and are disposed as time-division frame 2D images, similarly to FIGS. 3 to 6. When the display size of the parallax image is increased, the number of pixels per on parallax image is increased and the number of view points of the multi-view image is decreased. In comparison with FIGS. 3 to 6, in FIG. 11 to 14, the number of view points of the multi-view image is decreased from 16 (4×4) to 9 (3×3), the size of the parallax images is increased to 4/3 (□1.3) times in a length ratio, and accordingly, the number of pixels forming the parallax images is increased, thereby improving resolution of one parallax image. As a result, this provides an example of a proper 3D image reproducing method in case where “high resolution” has preference to “high cubic effect” in an image.

### Third Embodiment

FIG. 15 is a flow chart illustrating a 3D image reproducing method according to an embodiment of the present invention.

For reproduction of a 3D image, even if an cubic effect is insufficient in “3D image moving at a high speed” and “remote 3D image such as a scenery”, it has little effect on the sense of sight of human. On the contrary, when a cubic effect is insufficient in “3D image moving at a low speed” and “near 3D image”, a viewer may feel a sense of incongruity. In addition, when the number of changes of the multi-view image per one frame of the reproduced 3D image displayed on the transparent 2D image display device is increased in order to reproduce a 3D image having high cubic effect according to the method illustrated in the second embodiment, since time taken for display of one frame of the reproduced 3D image is lengthened, the display of the reproduced 3D image may not follow movement of an input 3D image, which may result in an unnatural image delay. Paying attention to this point, in the 3D image reproducing method shown in FIG. 11 to 14, when distance and movement are detected from an input 3D image signal 501 and an image quality determining part 502 selects resolution of the parallax images and the number of parallax images based on a result of the detection, an interpolation parallax image preparing part 503 prepares interpolation parallax images, and a transparent 2D image display device 504 and a dynamic point light source array 505 are cooperatively controlled so that quality of a 3D image according to use and characteristics of the 3D image can be automatically obtained.

For example, as shown in FIG. 15, when threshold values are set for movement and distance, respectively, and change of processes is made in real time, with 1) “display of a near 3D image at a high speed” being taken as “standard image quality” in the parallax image arrangement method shown in FIGS. 3 to 6, 2) “display of a near 3D image at a low speed” being taken as “cubic effect preference” in the parallax image arrangement method shown in FIGS. 7 to 10, and 3) “display of a remote 3D image” being taken as “resolution preference” in the parallax image arrangement method shown in FIGS. 11 to 14, the 3D image can be reproduced without having an unnatural image delay due to “lack of sensible cubic effect or lack of resolution”.

Although an example where two parallax image arrangement processes are changed with one threshold value has been shown in illustrate above, the invention may be also applied to cases where more parallax image arrangement processes are changed.

The 3D image reproducing apparatus and method according to the embodiments of the invention has an effect that a 3D image with both of “high resolution” and “high cubic effect” can be obtained even under a limited condition that the transparent 2D image display device is used.

### Fourth Embodiment

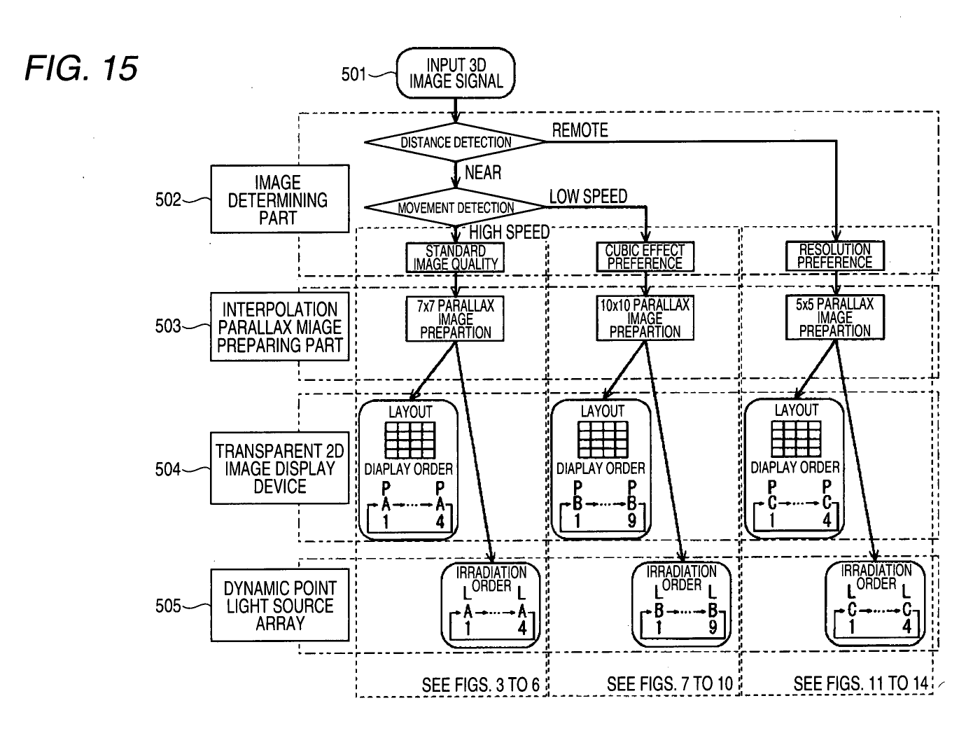

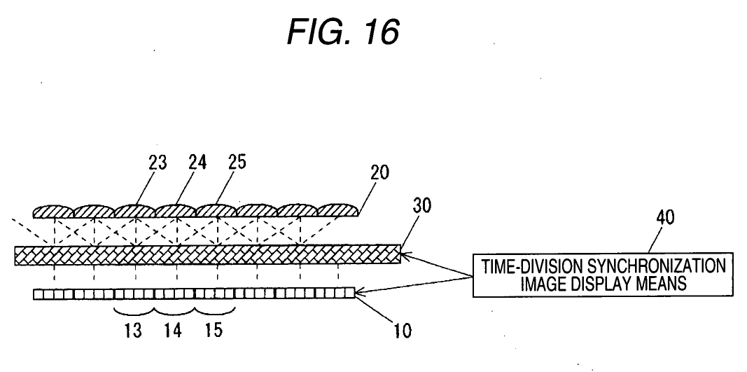

FIG. 16 shows constituent elements of the 3D image display device according to the first embodiment. The 3D image display device of this embodiment includes a display device 10, a lenticular lens sheet 20, an element image-element lens correspondence changing means 30, and a time-division synchronization image displaying means 40. The lenticular lens sheet 20 comprises a plurality of element lenses 23, 24 and 25, and the display device 10 comprises a plurality of element image displaying parts 13, 14 and 15. The element image displaying parts are a group of pixels for displaying an image (an element image) having a size corresponding to one element lens.

First, functions of the above components will be described. The display device 10 displays an element image corresponding to an element image displaying part according to an instruction from the time-division synchronization image displaying means 40. The displayed element image passes through one of the element lenses of the lenticular lens sheet 20 and is projected in an observer direction. The element image-element lens correspondence changing means 30 changes correspondence of an element image to an element lens according to an instruction from the time-division synchronization image displaying means 40. The time-division synchronization image displaying means 40 controls the element image-element lens correspondence changing means 30 to change the correspondence of an element image to an element lens in time division, and changes display of the display device 10 in synchronization with the change of the correspondence.

In this embodiment, a wide viewing angle is realized by changing a traveling direction of light passing through the lenticular lens sheet 20 in time division, changing corresponding element images to corresponding element image displaying parts, and displaying the element images on the corresponding element image displaying parts in synchronization. Now, the time-division change will be described with reference to FIG. 17. FIG. 17 is a view explaining an operation of the element image-element lens correspondence changing means 30 (M=3). Here, although a case where the number of changes of the element image-element lens correspondence changing means 30 is 3 will be described, the number of changes may be set randomly within a range in which an afterimage effect can be expected.

First, at time t1, the time-division synchronization image displaying means 40 instructs the element image-element lens correspondence changing means 30 to correspond an element image displaying part 14 to an element lens 23, and at the same time, displays an element image A (an image to be displayed in a direction in which the image is outputted from the element image displaying part 14 via the element lens 23) on the element image displaying part 14 for T1 seconds. Next, at time t2, the time-division synchronization image displaying means 40 instructs the element image-element lens correspondence changing means 30 to correspond an element image displaying part 14 to an element lens 24, and at the same time, displays an element image B (an image to be displayed in a direction in which the image is outputted from the element image displaying part 14 via the element lens 24) on the element image displaying part 14 for T2 seconds. In addition, at time t3, the time-division synchronization image displaying means 40 instructs the element image-element lens correspondence changing means 30 to correspond an element image displaying part 14 to an element lens 25, and at the same time, displays an element image C (an image to be displayed in a direction in which the image is outputted from the element image displaying part 14 via the element lens 25) on the element image displaying part 14 for T3 seconds. Since M=3, a time interval from t1 to t3 becomes one period. Thereafter, the same operation is repeated. T1, T2 and T3 are periods of time until next change (time taken for change may be neglected). T1, T2 and T3 have the same time interval which is less than a time interval during an afterimage effect can be perceived, preferably, 60 ms.

Although only one element image displaying part has been considered in the above description, all element image displaying parts, that is, the entire image of the display device can be displayed at once by corresponding other element image displaying parts to element lenses at t1, 42 and t3 timings in a similar way. In addition, although the division number N (the number of displays in one period or the number of changes of element lenses and element images) of time-division is set to equal to M, and only the tine-division control for the change of the correspondence of the element lenses to the element images is illustrated in the above description, it is possible to set N to be larger than M and divide one image into a plurality of partial images. For example, N may be set to four times M and an element image displaying part of the display device may be divided into four groups.

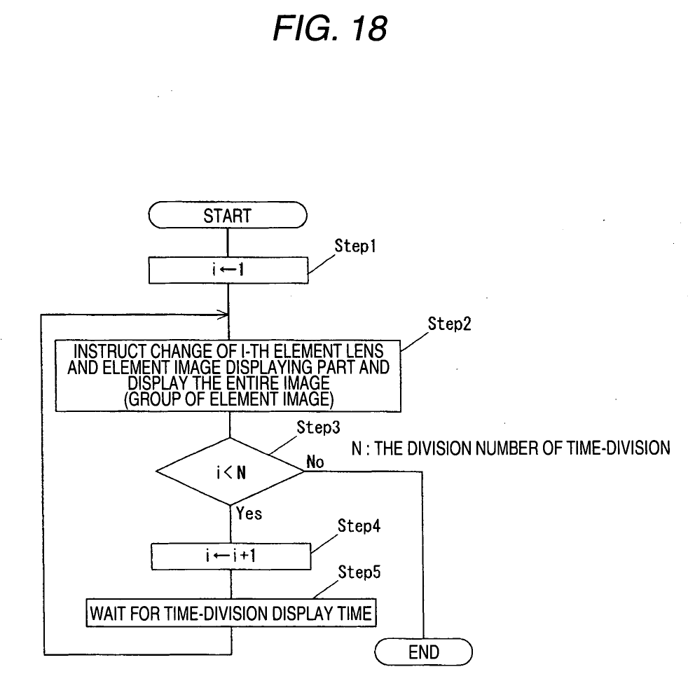

Subsequently, a process of the time-division synchronization image displaying means 40 will be described in more detail with reference to FIG. 18. FIG. 18 is a flow chart (for one period) illustrating an operation of the time-division synchronization image displaying means 40. Here, a case where the division number N of time-division is set to equal to M is considered. Correspondence between element lenses and element image displaying parts are predefined for states of the division number N of time-division. First, the time-division synchronization image displaying means 40 initializes a counter i (i=1) (Step 1). Next, based on correspondence of an i-th element lens to an element image displaying part, the time-division synchronization image displaying means 40 instructs the element image-element lens correspondence changing means 30 to change correspondence of element lens to element image displaying parts, and displays element images on corresponding element image display groups (Step 2). Next, if i<N (Step 3), the counter i is incremented by 1 (Step 4), time-division time T1 continues to be indicated (Step 5), and, thereafter, the process returns to Step 2. If i≧N, the process is ended. This process is performed in one period, and is repeated during display time.

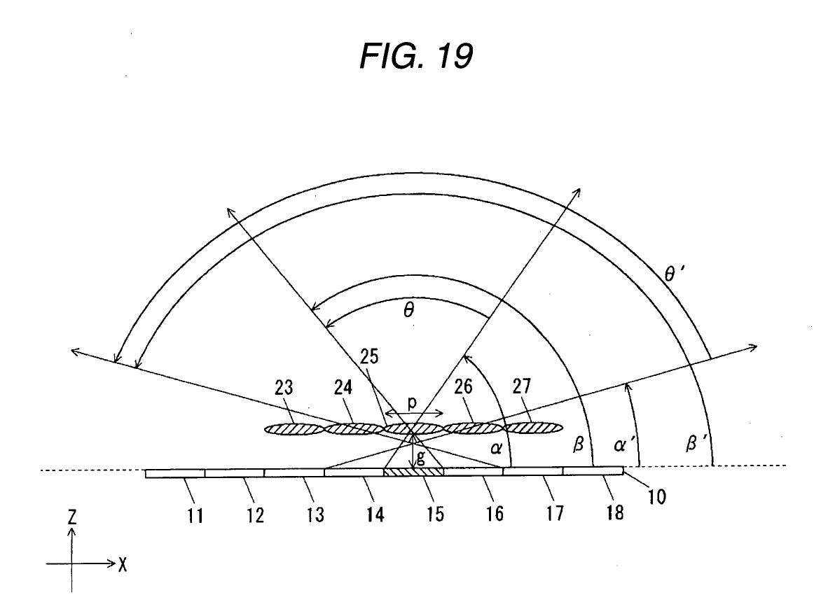

In the above-described embodiment, a cross-talk may be avoided and a viewing angle can be widened by changing the correspondence of the element lenses and the element image displaying parts in time-division. Now, the principle of widening the viewing angle will be described with reference to FIG. 19. FIG. 19 is a view explaining the principle of widening a viewing angle.

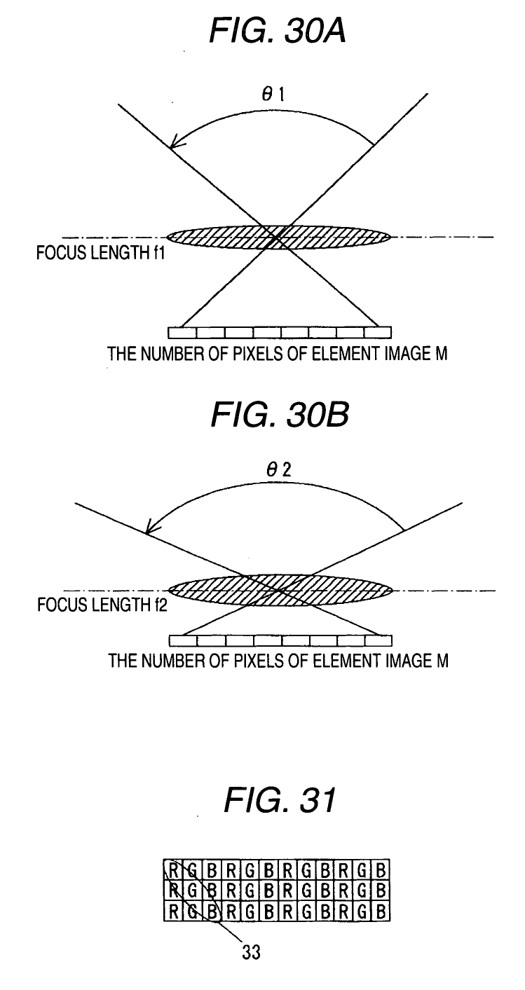

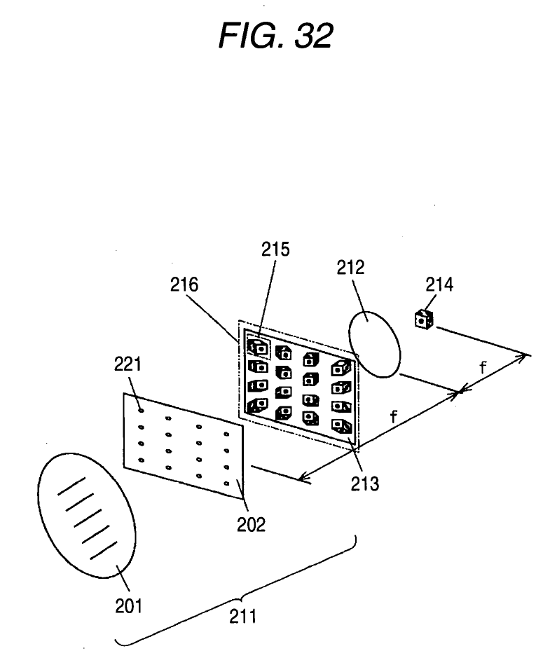

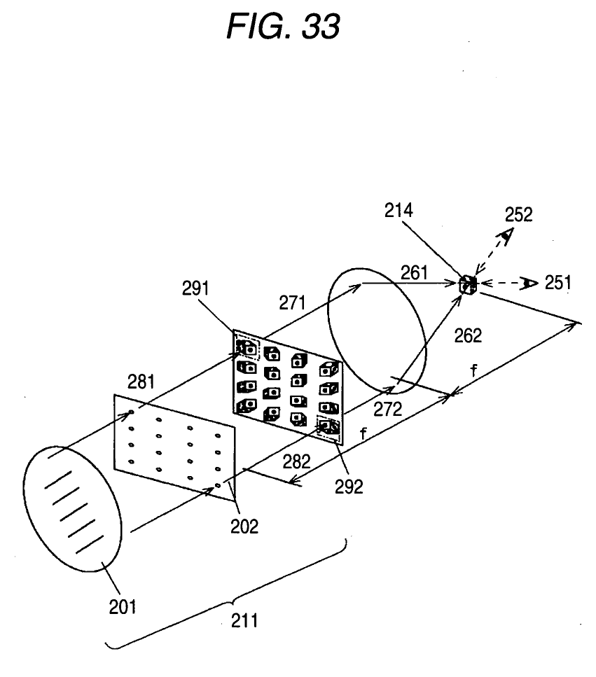

As shown in FIG. 19, X represents a direction in which lenses are arranged and Z represents a direction in which a viewer stands. An example of display of element images will be described using the element image displaying part 14 as a portion of a pixel of the display device 10. Element lenses 23 to 27 are arranged in substantial parallel to the display device 10, and pitches of element image displaying parts are set to substantially equal to pitches of element lenses. g represents a distance between the display device 10 and the element lenses 23 to 27 and p represents pitches of the element lenses 23 to 27. For a conventional IP method in which element lenses correspond to element image displaying parts in a one-to-one correspondence, as shown in FIGS. 30A and 30B, an element lens 25 corresponds to an element image displaying part 15, element image displaying parts 14 and 16 are adjacent to the element image displaying part 15, an angle range of a light beam passing through the center of the element lens 25 from the element image displaying part 15 is from α to β, and a viewing angle θ=β−α. In addition, for this method, a light beam having an angle less than α is incident into the element lens 26 and so on, and a light beam having an angle more than β is incident into the element lens 24 and so on, thereby occurring a cross-talk.

On the other hand, in this embodiment, in order to change the correspondence of the element image displaying parts and the element lenses with three sets (M=3), the element image displaying parts 14, 15 and 16 correspond to the element lenses 23, 24 and 25, respectively, at time t1, and an image to be projected in the left direction (a negative direction of the X axis) of FIG. 19 is displayed. At time t2, the element image displaying parts 14, 15 and 16 correspond to the element lenses 24, 25 and 26, respectively, and an image to be projected in the Z direction is displayed. At time t3, the element image displaying parts 14, 15 and 16 correspond to the element lenses 25, 26 and 27, respectively, and an image to be projected in the right direction (a positive direction of the X axis) of FIG. 19 is displayed. That is, there exist three combinations of the element lenses and the element image displaying parts that provide different viewing angles. An instantaneous viewing angle of each combination of the element lenses and the element image displaying parts is the same as in the conventional method, but since a viewing angle θ′ of the three combinations can be equal to θ′−α′ by changing the three combinations while an afterimage effect remains, an effective viewing angle becomes wider than the conventional viewing angle θ. If M is larger than 3 within a range in which the afterimage effect is expected, a viewing angle can be further widened, compared to the case of M=3.

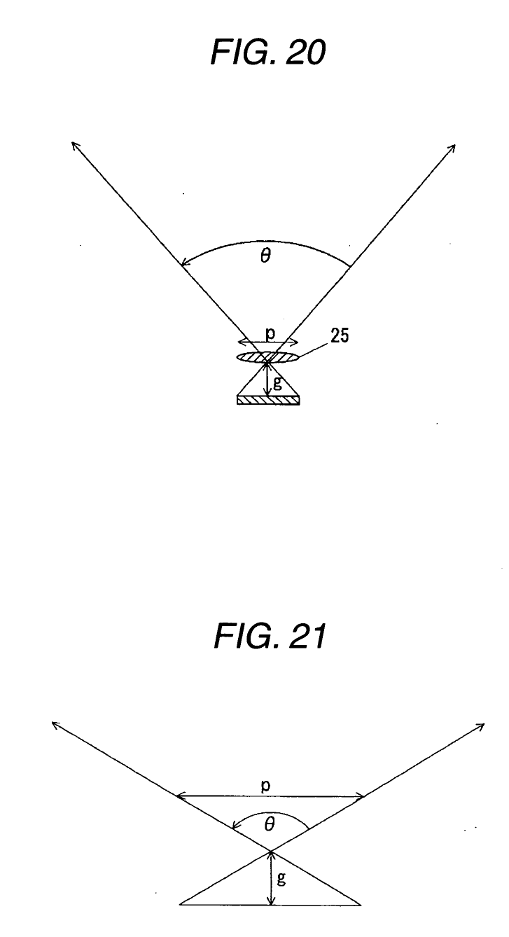

Next, a relationship between a viewing angle, a display device, a distance g between the display device and an element lens, and a pitch p of the element lens will be described. FIG. 20 is a simplified form of a portion of FIG. 19, and FIG. 21 is a simplified form of FIG. 20. As can be seen from FIG. 21, θ=2arctan(p/(2×g)) (corresponding to the above Equation 1). In this embodiment, if M=3, a widened viewing angle θ′=2arctan(3p/(2×g)). In general, for M of a range in which an after effect is expected, the viewing angle θ′=2arctan(Mp/(2xg)).

In addition, although the lenticular lens sheet 20 is used in this embodiment, different lenses such as a fly's eye lens may be employed.

As described above, in this embodiment, by changing the correspondence of the element lenses to the element image displaying parts in time-division, a cross-talk can be avoided and a viewing angle can be widened without increasing a scale of a display device or without using a plurality of display devices.

### Fifth Embodiment

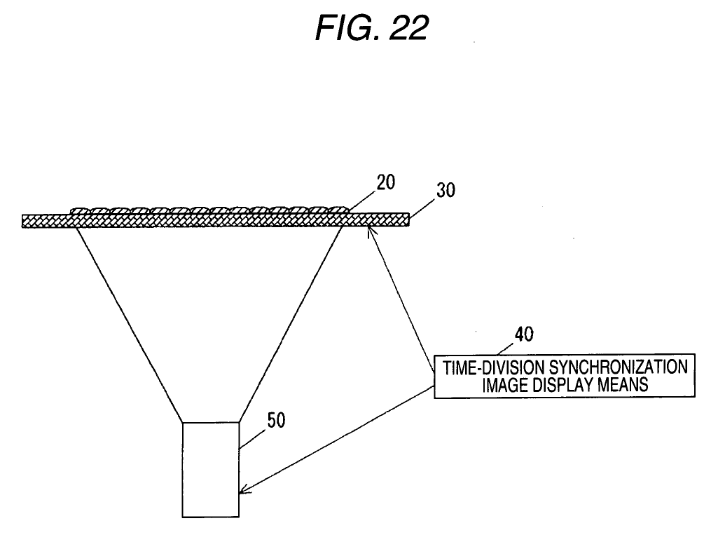

FIG. 22 shows constituent elements of the 3D image display device according to a fifth embodiment of the invention. In the fifth embodiment, components having the same functions as the fourth embodiment are denoted by the same reference numerals, and explanation of which will be omitted. In this embodiment, a projection-type display device 50 is used for display of an image. Although not shown, the projection-type display device 50 is a set of element image displaying parts for displaying an image (element image) having a size corresponding to one element lens, like the display device 10 of the fourth embodiment.

The time-division synchronization image displaying means 40 instructs the element image-element lens correspondence changing means 30 to change the correspondence of the element lenses to the element image displaying parts on the lenticular lens sheet 20 disposed in a traveling direction of a light beam on the projection-type display device 50 during or after projecting. An operational order of the change is the same as the fourth embodiment.

As described above, in this embodiment, by changing the correspondence of the element lenses to the element image displaying parts in time-division, a cross-talk can be avoided and a viewing angle can be widened without increasing a scale of a display device or without using a plurality of display devices.

### Sixth Embodiment

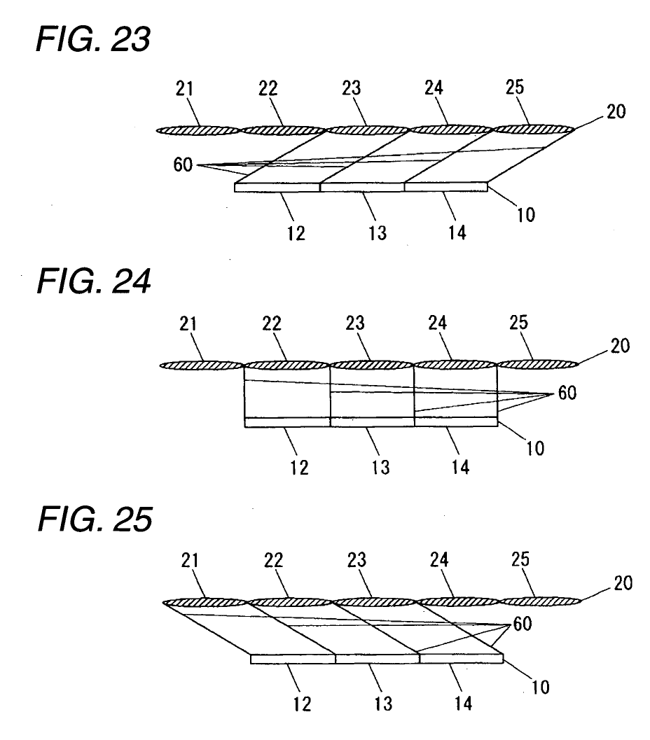

FIGS. 23, 24 and 25 show change of correspondence of element images to element lenses according to a sixth embodiment of the invention. In this embodiment, the element image-element lens correspondence changing means 30 is changed to open/close shutters 60, and the remaining components are the same as the fourth embodiment. In this embodiment, components having the same functions as the fourth embodiment are denoted by the same reference numerals, and explanation of which will be omitted. FIGS. 23, 24 and 25 show only main components of this embodiment. In this embodiment, the time-division synchronization image displaying means 40 in the fourth embodiment shown in FIG. 16 controls the open/close shutters 60 to change correspondence of the element image displaying parts and controls display of the element images of the display device 10.

The open/close shutters 60, which may be a waveguide-typed open/close shutter using an optical fiber, for example, operate as light path changing means for changing a path of light. As shown in FIGS. 23, 24 and 25, the open/close shutters 60 changes the correspondence of element lenses 23, 24 and 25 (FIG. 23), element lenses 22, 23 and 24 (FIG. 24) and element lenses 21, 22 and 23 (FIG. 25) on the lenticular lens sheet 20 to element image displaying parts 12, 13 and 14 on the display device 10 in order.

An operational order of the change is the same as the fourth embodiment.

As described above, in this embodiment, by changing the correspondence of the element lenses to the element image displaying parts in time-division, a cross-talk can be avoided and a viewing angle can be widened without increasing a scale of a display device or without using a plurality of display devices.

### Seventh Embodiment

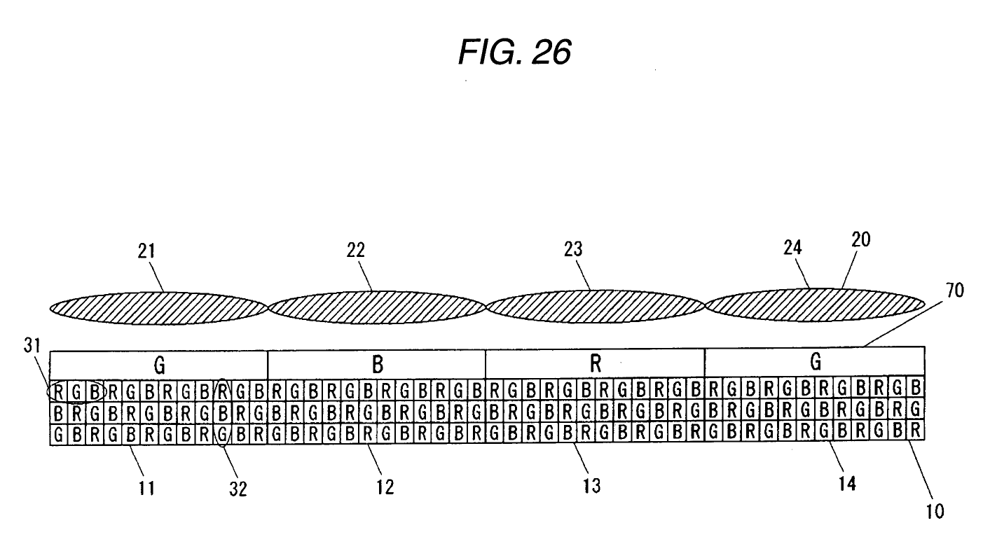

FIG. 26 shows constituent elements of the 3D image display device according to a seventh embodiment of the invention. In this embodiment, the element image-element lens correspondence changing means 30 is changed to wavelength selection filters 70, and the remaining components are the same as the fourth embodiment. In this embodiment, the display device 10 has R (red), G (green) and B (blue) sub pixels. FIG. 26 show only main components of this embodiment. In this embodiment, the time-division synchronization image displaying means 40 in the fourth embodiment shown in FIG. 16 controls the wavelength selection filters 70 to change correspondence of the element image displaying parts and controls display of the element images of the display device 10.

As shown in FIG. 26, each of pixels of the display device 10 comprises R, G and B sub pixels The wavelength selection filters 70 to selectively pass only one of R, B and B color light are disposed before the display device 10. Here, the wavelength selection filters 70 are so thin as not to have an affect on other components, except for wavelength selection. R, G and B recorded on the wavelength selection filters 70 indicate the transmission of red, green and blue color light, respectively.

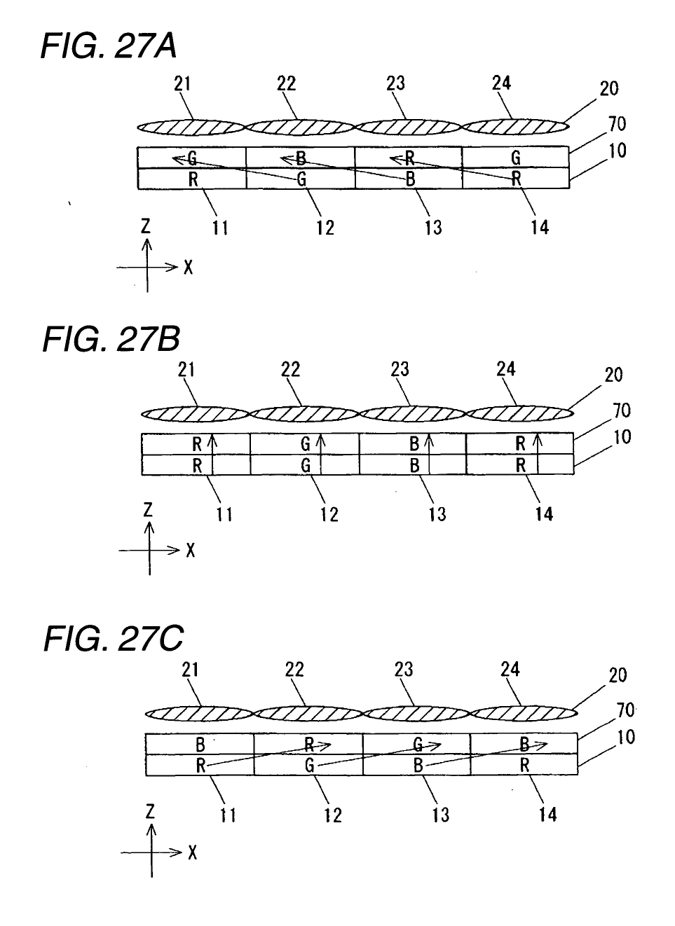

Now, display of an image and a changing method according to this embodiment will be described. Here, a case where RGB sub pixels are arranged in a mosaic pattern will be illustrated. The mosaic pattern refers to arranging the same RGB color obliquely, as shown in FIG. 26. Typically, when the mosaic pattern is used for a 2D image display, pixels are formed by horizontally arranged RGB, as indicated by a 2D pixel configuration 31. On the other hand, for a 3D image display to be required to provide more horizontal parallaxes, pixels are formed by vertically arranged RGB, as indicated by a 3D pixel configuration 32 in the mosaic pattern. The following description is focused on one color of RGB for each pixel displaying part of the display device. In FIG. 26, attention is paid to G for an element image displaying part 11, B for an element image displaying part 12, R for an element image displaying part 13, and G for an element image displaying part 14. FIGS. 27A to 27C show a positional relation between the wavelength selection filters 70 and three kinds of display devices 10. In FIGS. 27A to 27C, the display devices 10 indicate noted colors as R, G and B.

At time t1, in the positional relation of FIG. 27A between element image displaying parts and element lenses, G for the element image displaying part 12, B for the element image displaying part 13, and R for the element image displaying part 14 correspond to left element lenses 21, 22 and 23, respectively, by the wavelength selection filters 70. At time t2, in the positional relation of FIG. 27B, the element image displaying parts 11, 12, 13 and 14 correspond to the element lenses 21, 22, 23 and 24 immediately above the element image displaying parts 11, 12, 13 and 14, respectively. In addition, in the positional relation of FIG. 27C, the element image displaying parts 11, 12 and 13 correspond to the right element lenses 22, 23 and 24, respectively.

Although the case where RGB sub pixels are arranged in the mosaic pattern has been illustrated above, the RGB sub pixels may be arranged in a stripe pattern. In this case, the same effect as the mosaic pattern may be obtained by forming pixels with oblique RGB, as indicated by a 3D pixel configuration in the stripe pattern of FIG. 31, by, for example, tilting the lenticular lens sheet 20.

In this embodiment, when the time-division synchronization image displaying means 40 changes the above-mentioned three combinations in time-division, that is, when a relation between transmitting color light of the wavelength selection filters 70 and displayed color of the display devices is changed in time-division, the correspondence of the element lens to the element image displaying parts are changed to widen a viewing angle, as in the fourth embodiment.

In this manner, when the time-division synchronization image displaying means 40 changes three combinations of the positional relations between the wavelength selection filters 70 and the display devices 10 in time-division within a range in which an afterimage is expected, and repeats the process of changing element images displayed in synchronization with the time-division change, a cross-talk can be avoided and a viewing angle can be widened, as in the fourth embodiment.

In addition, for the change of the positional relations between the display devices 10 and the wavelength selection filters 70, the wavelength selection filters 70 are fixed to the lenticular lens sheet 20 and a relation between the lenticular lens sheet 20 and pixels of the display device 10 may be moved in a horizontal direction (a direction in which element lenses are arranged), or variable wavelength selection filters may be used.

As described above, in this embodiment, since the correspondence of the element lenses to the element images is changed using the wavelength selection filters 70, a cross-talk can be avoided and a viewing angle can be widened, without requiring a complicated light path changing mechanism.

### Eighth Embodiment

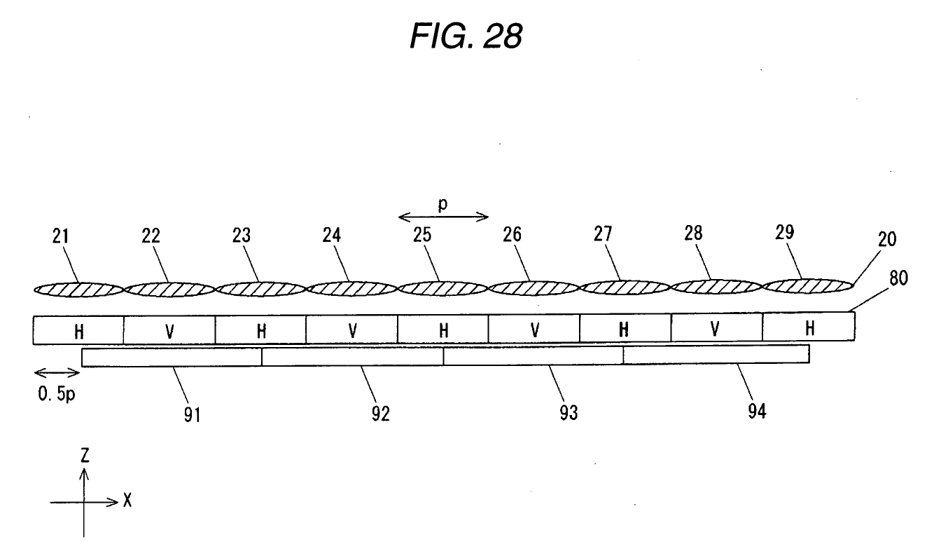

FIG. 28 shows constituent elements of the 3D image display device according to an eighth embodiment of the invention. In this embodiment, the element image-element lens correspondence changing means 30 is changed to a polarizing filter 80, width of element image displaying parts is changed, and the remaining components are the same as the fourth embodiment. FIG. 28 show only main components of this embodiment. In this embodiment, the time-division synchronization image displaying means 40 in the fourth embodiment shown in FIG. 16 controls the polarizing filter 80 to change correspondence of the element image displaying parts and controls display of the element images of the display device 10. In addition, the element image displaying parts of the display device 10 can display element images for each polarization, and the width of the element image displaying parts can be changed by the element image-element lens correspondence changing means 30.

Reference numerals 21 to 29 denote element lenses and a reference numeral 80 denotes a polarizing filter and reference numerals 91 to 97 denote element image displaying parts. The polarizing filter 80 has a configuration that element filters having polarization characteristic of H or V are alternately arranged. The element filters of the polarizing filter 80 have the same length as the element lenses. In FIG. 28, H and V represent a polarization direction. Here, the polarizing filter 80 is so thin as not to have an affect on other components, except for polarization.

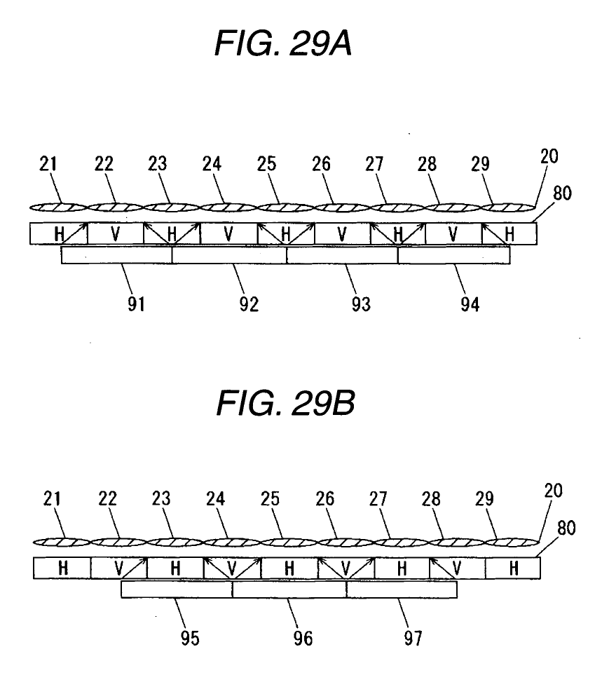

The element image displaying parts have double the width of the element lenses. p represents pitch of the element lenses. The width of the element image displaying parts of the display device 10 can be changed. FIG. 29A shows an example of a positional relation between the element lenses, the element image displaying parts and the polarizing filter in V polarization display of the display device. FIG. 29A is an explanatory view of an embodiment in which the element image-element lens correspondence changing means is taken as the polarizing filter. The element filters that transmit the V polarization are arranged immediately above the element image displaying parts. For example, an element image displaying part 91 has the same central X coordinate (direction in which the element lenses are arranged) as an element lens 22, and element lenses 21 and 23 are deviated by 0.5 p from the element image displaying part 91. In this case, element image displaying parts 91, 92, 93 and 94 correspond to element lenses 22, 24, 26 and 28 (indicated by arrows), respectively, such that V polarization display passes through only the V polarization filter.

FIG. 29B shows an example of a positional relation between the element lenses, the element image displaying parts and the polarizing filter in H polarization display. FIG. 29B is an explanatory view of an embodiment in which the element image-element lens correspondence changing means is taken as the polarizing filter. In the H polarization display, the time-division synchronization image displaying means 40 deviates the width of element image displaying parts of the display device 10 by ½ of the size of the element image displaying parts. For example, an element image displaying part 95 is constituted by the element image displaying part 91 and the element image displaying part 92 in the V polarization display. The element image displaying part 95 has the same central X coordinate as the element lens 23 and is deviated by 0.5 p from the element lenses 22 and 24, In this case, element image displaying parts 95, 96 and 97 correspond to element lenses 23, 25 and 27, respectively.

In this manner, the time-division synchronization image displaying means 40 changes the above-described two states in time-division within a range in which an afterimage is expected, and repeats the process of changing element images displayed in synchronization with the time-division change. In this embodiment, M=2, and a viewing angle θ=2arctan(p/g), which results in a viewing angle wider that a viewing angle obtained from the above Equation 1.

In addition, in this embodiment, the width of the element image displaying parts is changed while the H and V polarization displays are alternated. Alternatively, in the alternation between the H and v polarization displays, the polarizing filter 80 is fixed to the lenticular lens sheet 20 and a relation between the polarizing filter 80 and the display device may be moved in a horizontal direction (a direction in which element lenses are arranged), without changing the element image displaying parts.

As described above, in this embodiment, since the correspondence of the element lenses to the element images is changed using the polarizing filter 80, a cross-talk can be avoided and a viewing angle can be widened, without requiring a complicated light path changing mechanism.

As described above, the 3D image displaying apparatus and method of the invention are useful for 3D image display and particularly, are adaptable to a naked eye 3D image display system.

This application is based upon and claims the benefits of priority of Japanese Patent Applications Nos. JP2005-367712 filed on Dec. 21, 2005 and JP2006-235232 filed on Aug. 31, 2006, the contents of which are incorporated herein by reference in its entirety.

It is noted that the foregoing examples have been provided merely for the purpose of explanation and are in no way to be construed as limiting of the present invention. While the present invention. While the present invention has been described with reference to exemplary embodiments, it is understood that the words which have been used herein are words of description and illustration, rather than words of limitation. The above embodiments can be combined one another and the combinations of the embodiments are, of course, within the scope of the present invention. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

What is claimed is:

1. A three-dimensional image reproducing apparatus for reproducing a three-dimensional image by reproducing a plurality of light rays passing through a reproduction position of the three-dimensional image by a plurality of different parallax images, with a traveling direction of the light rays as a viewing direction, comprising:
a dynamic point light source array that dynamically controls at least one of positions of point light sources, the number of the point light sources, and diameter of the point light sources;
an image forming lens that is spaced apart by a focus length from the dynamic point light source array;
a transparent two-dimensional image display device that is interposed between the dynamic point light source array and the image forming lens; and
a controller that coordinately controls the at least one of the positions of point light sources, the number of point light sources and the diameter of point light sources of the dynamic point light source array, a viewing direction of a parallax image on a display image of the transparent two-dimensional image display device, and a parallax image display region position on the transparent two-dimensional image display device.

2. A multi-ocular three-dimensional image reproducing method for reproducing a three-dimensional image by reproducing a plurality of light rays passing through a reproduction position of the three-dimensional image by a plurality of different parallax images, with a traveling direction of the light rays as a viewing direction, the method comprising:
periodically changing a viewing direction of each of the parallax images, a position and size of a display region on a parallax image display device, and irradiation position, irradiation number and irradiation direction of the light rays reproduced by the parallax images.

3. The method according to claim 2, wherein
the three-dimensional image is reproduced by using a dynamic point light source array that dynamically controls at least one of positions of point light sources, the number of point light sources, and diameter of point light sources, an image forming lens that is spaced apart by a focus length from the dynamic point light source array, and a transparent two-dimensional image display device that is interposed between the dynamic point light source array and the image forming lens are provided, and
the changing step includes periodically changing the viewing direction of each of the parallax images on the transparent two-dimensional image display device, the position of a display region of the parallax image on the transparent two-dimensional image display device, and the positions of point light sources, the number of point light sources, and the diameter of point light sources of the dynamic point light source array.

4. The multi-ocular three-dimensional image reproducing method according to claim 2, wherein resolution of the parallax image and the number of parallax images are changed to according to a characteristic and use of a display three-dimensional image.

5. A three-dimensional image displaying apparatus comprising:
a two-dimensional image displaying part that includes a plurality of element image displaying parts for displaying element images;
a lens array that is disposed in a light ray traveling direction of the two-dimensional image displaying part and includes a plurality of element lenses that pass light rays of the element image displaying parts;
an element image-element lens correspondence changing part that changes correspondence of the element image displaying parts to the element lenses that pass the light rays from the element image displaying parts; and
a time-division synchronization image displaying part that instructs the element image-element lens correspondence changing part to change the correspondence of the element image displaying parts to the element lenses and displays the element images on the element image displaying part in time-division in synchronization with the instruction.

6. The three-dimensional image display apparatus according to claim 5, wherein the two-dimensional image displaying part comprises a projection-typed displaying part.

7. The three-dimensional image display apparatus according to claim 5, wherein the element image-element lens correspondence changing part comprises a light path changing part.

8. The three-dimensional image display apparatus according to claim 5, wherein the element image-element lens correspondence changing part comprises a wavelength selection filter.

9. The three-dimensional image display apparatus according to claim 5, wherein the element image-element lens correspondence changing part comprises a polarizing filter.

10. The three-dimensional image display apparatus according to claim 5, wherein the division number of element images displayed on the element image displaying part in time-division is equal to the number of changes of the element image-element lens correspondence changing part.

11. The three-dimensional image display apparatus according to claim 5, wherein a viewing angle θ of a three-dimensional image satisfies an equation of θ>2arctan(p/(2g)) (where, p is a pitch of an element lens and g is a distance between the two-dimensional image displaying part and the lens array).

12. A three-dimensional image displaying method of projecting a three-dimensional image by displaying a plurality of element images and passing the three-dimensional image through a lens array comprising element lenses corresponding to the element images, the method comprising:
displaying the plurality of element images on element image displaying parts;
instructing change of the element image displaying part and the element lenses corresponding to the element image displaying parts;
changing correspondence of the element image displaying parts to the element lenses based on the instruction; and
repeating the steps of displaying, instructing, and changing by the number of changes of the correspondence of the element images to the element lens.
